(19) United States
(12) Patent Application Publication
(10) Pub. No.: US 2008/0244434 A1
(43) Pub. Date: Oct. 2, 2008

(54) Information Service Program, Information Service Apparatus, and Information Service Method

(75) Inventor: Noriyuki TAKEI, Shiojiri-shi (JP)

Correspondence Address: HOGAN & HARTSON L.L.P., 1999 AVENUE OF THE STARS, SUITE 1400, LOS ANGELES, CA, 90067, US

(73) Assignee: SEIKO EPSON CORPORATION, Tokyo (JP)

(21) Appl. No.: 12/055,062

(22) Filed: Mar. 25, 2008

(30) Foreign Application Priority Data
Mar. 29, 2007 (JP) 2007-087307

(51) Int. Cl. G06F 3/048

(52) U.S. Cl. 715/771

(57) ABSTRACT

An information service program which causes an information service apparatus perform processing of information service about optional devices which are mountable in an object apparatus, the processing including a process of determining present configuration of the object apparatus including mounted optional devices which are mounted in the object apparatus, and non-mounted optional devices which are optional devices which are not mounted but are mountable in the object apparatus, by acquiring information about mounting status of the optional devices in the object apparatus and a process of displaying an appearance image of the object apparatus, which is to be configured when the non-mounted object devices are further additionally mounted in the object apparatus, to a user so that the user can discriminate between the present configuration of the object apparatus and the non-mounted optional devices.

### CROSS-REFERENCE TO RELATED APPLICATION

This application is based upon and claims the benefit of priority from the prior Japanese Patent Application No. 2007-87307, filed on Mar. 29, 2007, the entire contents of which are incorporated herein by reference,

### BACKGROUND

1. Technical Field

The present invention relates to a computer readable medium recording an information service program which can provide information about optional devices that are mountable in an object apparatus such as a printer, and more particularly to a computer readable medium recording an information service program that can provide a user with information about non-mounted optional devices which are not mounted but are mountable in the object apparatus so that the user readily discriminate the non-mounted optional devices which are not mounted but are mountable in the object apparatus at the time.

2. Related Art

Generally, optional devices that can be optionally mounted are prepared for apparatuses such as a printer and a copying machine, For example, when the apparatus is a printer, a plurality of kinds of memories with different capacities, an HDD unit, and a plurality of kinds of sheet feeding devices are prepared as optional devices.

Moreover, in the case of a printer, a printer driver provided in a host device thereof carries out information service to a user about these optional devices. In detail, when two-way communication between the host device and the printer is possible, the printer driver specifically acquires information about the optional devices, which are mounted in the printer, from the printer, and displays a list of names of the mounted optional devices. Moreover, when the two-way communication is impossible, a user sets up the mounting status of the optional devices in the printer driver by inputting the mounting status into the host device, and thus displays the setup information in the list form. In addition, such information service is not displayed on a basic setting window used for a setup and a display about a basic items among user interface windows prepared for various condition setups about printing performed by the printer, but is displayed on a details setting window for performing a setup and a display about a detailed item.

Information service about such optional devices is disclosed in Japanese Patent No. 3017605, Japanese Patent No. 3740216, and JP-A-2004-21400. In detail, JP-R-3017605 discloses that the mounting status of optional devices is expressed by an appearance image, JP-R-3740216 discloses that displayed contents are changed according to the mounting status of optional devices, and JP-A-2004-21400 discloses a technique of automatically acquiring information about the configuration of a printer.

However, in the conventional methods of information service about optional devices, emphasis of the information service is put on the optional devices being in the mounted state at the time, but information about the optional devices, which are not mounted but are mountable at the time, is not provided to a user in an easily distinguishable manner.

Thus, since information about the non-mounted optional devices is not offered in easily distinguishable expression, it is inconvenient to effectively use an apparatus such as a printer when a user is going to pursue the efficient and useful usage of the apparatus by using the optional devices, it is not fruitful to motivate a user who is newly going to purchase optional devices, and it has become a factor which makes venders of the apparatus, such as a printer miss the sales opportunities of optional devices.

### SUMMARY

An advantage of some aspects of the invention is that it provides a computer readable medium recording an information service program which performs information service about optional devices that are mountable in an apparatus, such as a printer, and an information service program which can offer a user information about optional devices that are not mounted but are mountable in the apparatus at the time in easily distinguishable expression.

According to one aspect of the invention, there is provided a computer readable medium recording an information service program which makes an information service apparatus execute processing of information service about optional devices which can be mounted in an object apparatus, in which the processing includes a process of determining present configuration of the apparatus including the optional devices which are mounted, and non-mounted optional devices which are not mounted but are mountable in the object apparatus by acquiring information about mounting status of the optional devices in the object apparatus, and a process of displaying an appearance image of the object apparatus at the time of being equipped with the non-mounted optional devices to a user so that the user can discriminate between the present configuration and the non-mounted optional devices.

In such an aspect, it is preferable that images showing the optional devices mounted inside the object apparatus are displayed together with the appearance image.

Furthermore, it is preferable that images showing the non-mounted optional devices are displayed near the displayed appearance image.

In such an aspect, it is preferable that images showing the mounted optional devices are displayed near the appearance image to be distinguishable from the images showing the non-mounted optional devices.

In such an aspect, it is preferable that the images showing the non-mounted optional devices are displayed in a manner such that whether the non-mounted optional devices can be added to the present configuration of the object apparatus can be discriminated.

In such an aspect, it is preferable that the information service apparatus provides an interface window which allows a user to perform setting operation about the object apparatus and which consists of a basic setting window and a details setting window, and the display of the appearance image is performed on the basic setting window.

In such an aspect, it is preferable that the object apparatus is a printer, and the information service apparatus the printer or a host device of the printer.

According to another aspect of the invention, there is provided an information service apparatus which performs information service about optional devices which can be mounted in an object apparatus, the information service apparatus including an information acquisition unit which determines present configuration of the object apparatus including mounted optional devices which are mounted in the object apparatus, and non-mounted optional devices which are optional devices which are not mounted but are mountable in the object apparatus, by acquiring information about mounting status of the optional devices in the object apparatus, and an information display unit which displays an appearance image of the object apparatus at the time of being equipped with the non-mounted optional devices to a user so that the user can discriminate between the present configuration of the object apparatus and the non-equipped optional devices.

According to a further aspect of the invention, there is provided an information service method in an information service apparatus which performs information service about optional devices that can be mounted in an object apparatus, the information service method including a process of allowing the information service apparatus to determine present configuration of the object apparatus including mounted optional devices which are mounted in the object apparatus, and non-mounted optional devices which are optional devices which are not mounted but are mountable in the object apparatus, by acquiring information about mounting status of the optional devices in the object apparatus, and a process of allowing the information service apparatus to display an appearance image of the object apparatus at the time of being equipped with the non-mounted optional devices to a user so that the user can discriminate between the present configuration of the object apparatus and the non-mounted optional devices.

### BRIEF DESCRIPTION OF THE DRAWINGS

The invention will be described with reference to the accompanying drawings, wherein like numbers reference like elements.

FIG. 1 is a view illustrating a hardware structure of an information service apparatus according to one embodiment.

FIG. 2 is a functional diagram illustrating functional blocks of a host computer 1 and a printer 2.

FIG. 3 is a flow chart illustrating the procedure of display processing of a basic setting window.

FIG. 4 is a view illustrating an example of option information which is stored.

FIGS. 5A to 5A are views illustrating an example of a basic setting window.

### DESCRIPTION OF EXEMPLARY EMBODIMENTS

The further advantages and features of the invention will be more apparent from embodiments explained below.

Hereafter, embodiments of the invention will be explained with reference to the accompanying drawings. However, the embodiments do not limit the technical scope of the invention. In addition, in the drawings, like or similar elements are referenced by like reference numbers or signs.

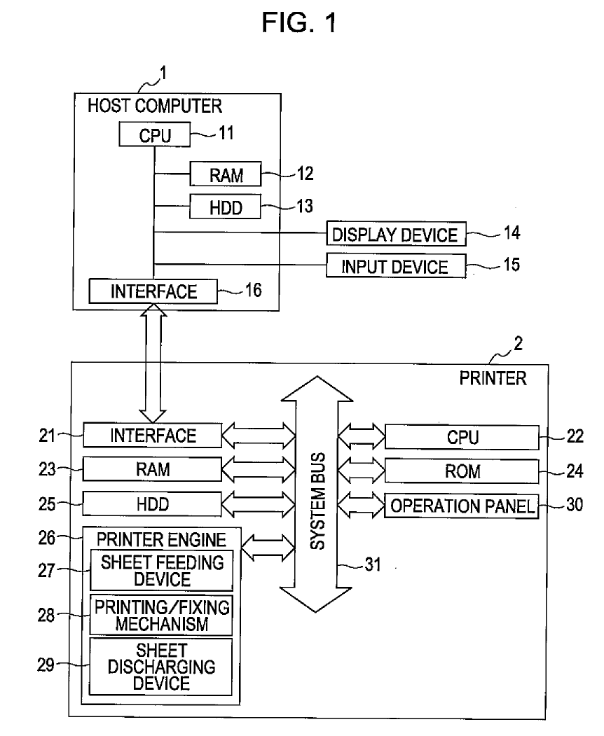

FIG. 1 shows a hardware structure of an information service apparatus according to one embodiment of the invention. In FIG. 1, a host computer 1 corresponds to the information service apparatus to which the invention is applied. Further, a driver for a printer 2 connected to the information service apparatus, in a basic setting window for a printing setup, tries to perform information service intelligibly for a user about optional devices by displaying an appearance image of the printer 2 configured at the time of being equipping with non-mounted optional devices which are not mounted at the time but are mountable in a manner such that present configuration of the apparatus and the non-mounted optional devices can be discriminated from one another.

In this embodiment, the apparatus equipped with optional devices is the printer 2 of FIG. 1, and the host computer 1 provides the user with information service about the optional devices.

As the host computer 1 can be a general personal computer and thus, as shown in FIG. 1, the hardware thereof is made up of a central processing unit (CPU) 11, a random access memory (RAM) 12, a hard disc drive (HDD) unit 13, an interface 16 for communication with external apparatuses, a display device 14 such as a monitor, and an input device 15 such as a keyboard and a mouse.

Moreover, as an example, the printer 2 is a laser beam printer and, as shown in FIG. 1, the hardware thereof is made up of an interface 21 for communication with the host computer 1, a central processing unit (CPU) 22, a random access memory (RAM) 23, a read only memory (ROM) 24, a hard disc drive (HDD) unit 25, a printer engine 26, an operation panel 30, and a system bus 31. The printer engine 26 performs a printing job to print media, and includes a sheet feeding device 27, such as a paper cassette for supplying print media, a printing/fixing mechanism 28 which executes the printing job, and a sheet discharging device 29 for discharging the print media after the printing.

Moreover, the printer 2 can be equipped with some optional devices, and optional devices are prepared for memories, such as the RAM 23, the HDD 25, and the sheet discharging device 29,

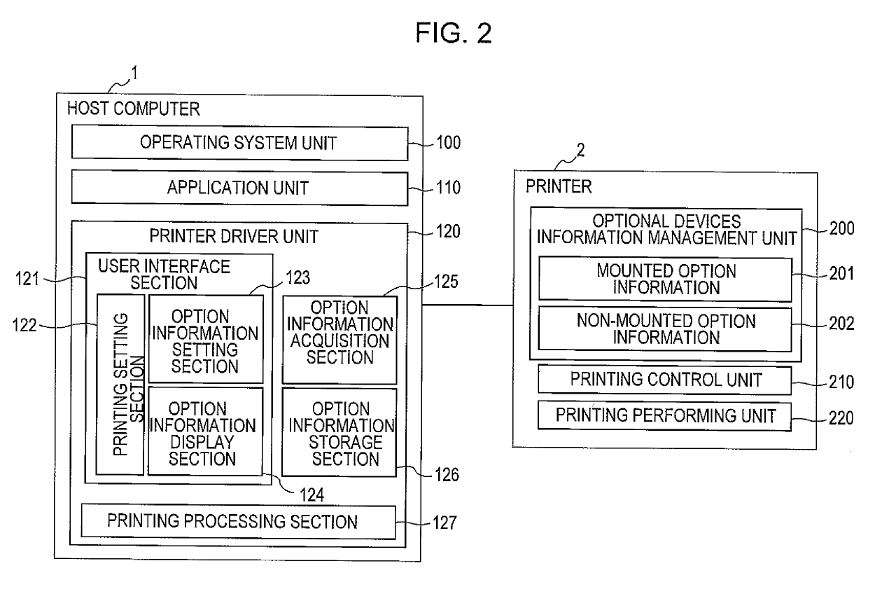

FIG. 2 shows the functional structure of the host computer 1 and the printer 2. As shown in FIG. 2, the host computer 1 can be equipped with an operating system unit 100, an application unit 110, and a printer driver unit 120. The application unit 110 is a portion that issues a request to print something created thereof with the printer 2 and, for example, is composed of a document creating software.

The printer driver unit 120 is a driver for driving the printer 2, and is made up of a driver program stored in the HDD 13 and the CPU 11 which performs processing according to the driver program stored in the HDD 13 etc. As shown in FIG. 2, the printer driver unit 120 includes a user interface section 121 having a printing setting section 122 which allows a user to perform various setup, such as printing conditions setup, to the printer 2 and a printing processing section 127 which receives the request from the application unit 110, produces printing data conforming the printing conditions, transmits the printing data to the printer 2, and instructs the printer 2 to perform the printing job of the printing data.

Moreover, the printer driver unit 120 can be provided with a function of information service about the optional devices of the printer 2. As shown in FIG. 2, in order to realize such a function, the printer driver unit 120 is made up of an option information setting section 123 and an option information display section 124 of the user interface section 121, an option information acquisition section 125, and an option information storage section 126.

The option information setting section 123 enables the information input by a user about the mounting status of the optional devices of the printer 2, and the option information acquisition section 125 performs processing of acquiring the information about the mounting status of the optional devices from the printer 2. Moreover, the option information storage section 126 stores the option information acquired by the option information setting section 123 and the option information acquisition section 125. The option information display section 124 displays the option information stored in the option information storage section 126 to a user. Details of the features of the information service about the optional devices performed in these four sections will be described later. In addition, the program which bears the function of these four sections corresponds to the information service program to which the invention is applied.

Next, as shown in FIG. 2, the printer 2 functionally consists of an option information management unit 200, a printing control unit 210, and a printing performing unit 220. The printing control unit 210 is a controller. The printing control unit 210 performs printing directions by receiving the printing data transmitted from the host computer 1, performing predetermined data processing, and then transmitting the processed data to the printing performing unit 220. The printing performing unit 220 corresponds to the printer engine 26 and performs the printing processing to the print media according to the printing directions.

Moreover, the option information management unit 200 is a portion which manages the information about the optional devices that can be mounted in the printer 2. Thus, the option information management unit 200 grasps the mounting status of the optional devices at predetermined timing, and preserves mounted option information 201 which is information about the optional devices mounted in the printer 2 and non-mounted option information 202 which is information about the optional devices which are not mounted in the printer 2. Further, the information is transmitted according to the demand from the option information acquisition section 125 of the host computer 1. In addition, the mounted option information 201 and the non-mounted option information 202 are stored in the RAM 23, and the option information management unit 200 is realized by operation of the CPU 22, which follows the program stored in the ROM 24 as part of a controller. Moreover, the non-mounted option information 202 may not be stored and preserved.

As for the host computer 1 and the printer 2 concerning this embodiment, which has the structure explained above, the feature is the information service about the optional devices to the user by the host computer 1. The detailed contents will be explained hereafter.

In addition, the printer driver unit 120 provides the setting window for allowing a user to perform various setup of the printer 2, and the setting window consists of a basic setting window for enabling a setup about a basic item, and a plurality of details setting windows for enabling a setup about detailed items or special items. Since the feature of the invention is put on the information service about the optional devices performed by the basic setting window, display processing of the basic setting window will be explained hereafter. In addition, the basic setting window enables browse and setting change of the present contents of the settings about items, such as printing quality, paper size, and paper kind. Moreover, the details setting window enables the setting about items, such as a layout and a page decoration at the time of printing.

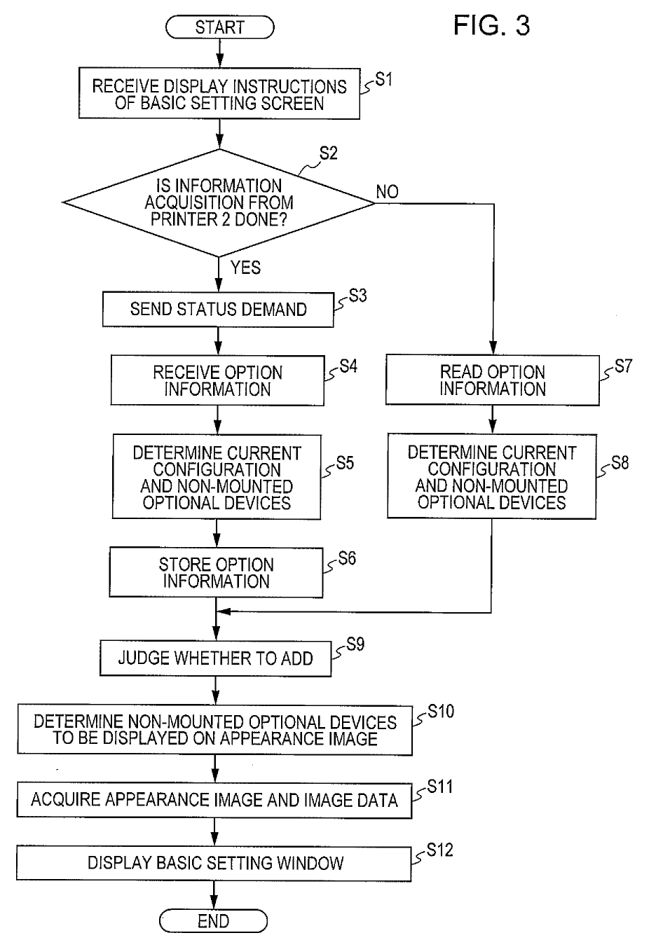

FIG. 3 is the flow chart illustrating the procedure of display processing of the basic setting window. First, a user gives display instruction of the basic setting window. Specifically the user selects the menu of property about the printer 2 from the window for a printing demand, which is provided by the application unit 110. Alternatively, the user can give the display instruction of the basic setting window by selecting the menu of printing setup from the user interface window, which is provided by the printer driver unit 120.

Display instruction of the basic setting window is received by the user interface section 121 of the printer driver unit 120 (Step S1), and it is then determined whether the information acquisition from the printer 2 should be performed (Step S2). Here, the printer driver unit 120 may determine whether to perform the information acquisition according to the contents preliminarily set up by the user, or may determine according to presence and absence of two-way communication between the host computer 1 and the printer 2. That is, the printer driver unit 120 may determine such that the information acquisition should be performed when the two-way communication is possible but conversely determine such that the information acquisition should not be performed when the two-way communication is impossible.

In the determination, when it is determined such that the information acquisition from the printer 2 should be performed (Yes at Step S2), the printer driver unit 120 sends a status demand to the printer 2 (Step S3). The status demand is an asking for the present status of the printer 2, and thus the printer 2 answers the host computer 1 with various-kinds of status information according to the demand. The status information includes the mounted option information 201 and the non-mounted option information 202 managed by the option information management unit 200 of the printer 2.

The option information acquisition section 125 receives the mounted option information 201 and the non-mounted option information 202 in the transmitted status information (Step S4). The option information acquisition section 125 determines the present configuration (basic configuration and mounted optional devices) of the printer 2, and non-mounted optional devices which are not mounted but are mountable in the printer 2 at the time by the information (Step S5).

Here, when the non-mounted option information 202 is received, the uninstalled optional device is confirmed by this information. Therefore, the non-mounted optional device is determined by the transmission of this information. On the other hand, when the non-mounted option information 202 is not stored in the printer 2 and only the mounted option information 201 is received, the uninstalled optional device is determined by comparing a list of all optional devices installable on the printer 2 that has been saved in advance in the printer driver unit 120 and a list of presently installed optional devices that are indicated by the mounted option information 201.

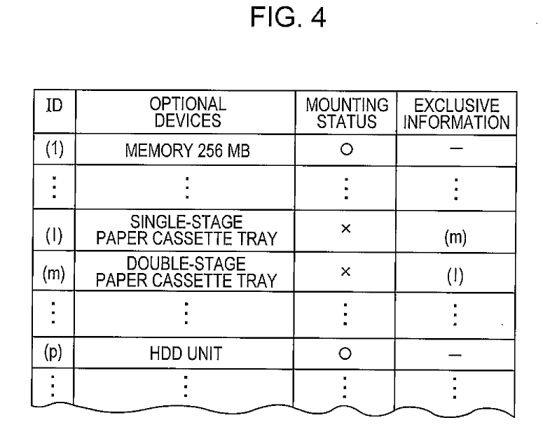

Next, the option information storage section 126 stores the option information that can be acquired by the reception and determination of the information to a registry of the operating system unit 100 (Step S6). Specifically, the presence and absence of all the optional devices, which can be mounted in the printer 2, in the printer 2 are recorded. FIG. 4 shows an example of the stored information.

In the table shown in FIG. 4, “ID” at the left end column in the table shows identification information of the optional devices which can be mounted in the printer 2, “optional devices” at the second column from the left shows names of the optional devices which can be mounted in the printer 2, and “mounting status” at the third column from the left shows presence and absence of the optional devices in the printer 2. Such information is stored in the registry of the operating system unit 100, and the information about the “mounting status” is updated in memory processing of the option information according to the mounting status at that time.

In the example shown in FIG. 4, the printer 2 is equipped with a memory of 256 MR and an HDD unit but is not equipped with a single-stage paper cassette tray and a double-stage paper cassette tray, namely, what are the non-mounted optional devices.

On the other hand, when it is determined in Step S2 such that the information acquisition from the printer 2 is not performed, (No at Step S2), the option information acquisition section 125 reads the option information stored in the registry of the operating system unit 100 at the time (Step S7), and determines the current configuration and the current non-mounted optional devices of the printer 2 as in the read information (Step S8). That is, the optional devices, which the stored option information tells that they are mounted in the printer 2, are included in the current configuration, and the optional devices, which the stored option information tells that they are not mounted in the printer 2, are classified as the non-mounted optional devices.

In addition, the stored option information can be suitably updated by a user when two-way communication between the host computer 1 and the printer 2 is not possible. In greater detail, when a user specifically changes the mounting status of optional devices, such as having mounted optional devices in the printer 2, the update can be accomplished by performing operation of setting the mounting status at a predetermined portion in the details setting window. At this time, the option information setting section 123 updates the option information stored in the registry so as to be matched with the updated mounting status on the basis of the information inputted by the user's operation.

Thus, at any cases, when the current configuration and the current non-mounted optional devices are determined (S5, S8), the option information acquisition section 125 determines whether further optional devices can be added to the printer without removing the optional devices which have been mounted already (Step S9). Specifically the determination depends on the exclusive information about each of the optional devices, which is stored in the host computer 1. This exclusive information is stored in the registry of the operating system unit 100 in the state of being linked with information of “mounting status.”

The “exclusive information” at the right end column of FIG. 4 shows the exclusive information. In addition, in the example shown in FIG. 4, one device for the memory (256 MB memory) can be installed and one device for HDD unit can be installed, regardless of other optional devices. Moreover, as for a sheet feeding device, one cassette from among the single-stage paper cassette and double-stage paper cassette can be installed.

Therefore, in FIG. 4, the single-stage paper cassette tray (l) cannot be mounted in the case in which the double-stage paper cassette tray (m) is mounted, and in other words, the double-stage paper cassette tray (m) cannot be mounted in the case in which the single-stage paper cassette tray (l) is mounted. Accordingly, the “exclusive information” of the single-stage paper cassette (l) is “(m)” which indicates the double-stage paper cassette tray. In the similar way, the “exclusive information” of the double-stage paper cassette tray (m) becomes “(l)” which indicates the single-stage paper cassette tray (l).

The option information acquisition section 125 determines whether each of the non-mounted optional devices can be added to the current configuration at the time on the basis of “exclusive information” and “mounting status” of the current status mentioned above. In the example shown in FIG. 4, the optional devices indicated by the exclusive information with respect to the single-stage paper cassette (l) and double-stage paper cassette (m) have not been installed. Therefore, it is determined that these cassettes can be installed.

In addition, in FIG. 4, only one memory of one kind can be installed, but this is merely an example, and a plurality of memory devices of a plurality of kinds may be also installed at the same time.

Next, the option information acquisition section 125 determines the non-mounted optional devices to be displayed on the appearance image (Step S10). The appearance image of the printer 2 at the time of equipping with the non-mounted optional devices is expressed in the basic setting window of the host computer 1 as described above, at this step, the non-mounted optional devices to be included in the appearance image, i.e. the non-mounted optional devices which are to be displayed together with the appearance image at the time of mounting will be determined.

Specifically, as for the non-mounted optional devices determined as being additionally mountable by Step 9, it is determined that all such non-mounted optional devices are altogether included in the appearance image. That is, the appearance image in which as many as possible optional devices are added to the present configuration is displayed. However, as for the optional devices shown in the exclusive information, they can not be mounted at the same time with other optional devices. Accordingly, it is determined such that only the non-mounted devices that can be simultaneously mounted is included in the appearance image.

Although selection of the non-mounted optional devices that can be simultaneously mounted can be performed by various methods, one exemplary method is that it can choose non-mounted optional devices that makes overall size of the apparatus largest when the chosen non-mounted optional devices are mounted in the apparatus. When adopting such a method, the largest size of the image of the object apparatus at the time of adding the optional devices to the present configuration will be demonstrated to a user, so that it is possible to provide the user with the effective information when the user is going to contemplate arrangement of the printer 2. There may be a further exemplary method that the optional devices are selected according to a predetermined order which is determined on the basis of the IDs of the optional devices.

In the example shown in FIG. 4, it is in the state in which the single-stage paper cassette tray (l) and the double-stage paper cassette tray (m) can be added, since it is not possible to mount both of the single-stage paper cassette tray and the double-stage paper cassette tray at the same time, one of the optional devices is selected and thus only the selected optional device is included in the appearance image. That is, the double-stage paper cassette tray (m) is chosen by the former method that the optional devices are selected so that the outside dimension of the object apparatus becomes the largest, and the single-stage paper cassette tray (l) is chosen by the latter method based on the order of the IDs.

In addition, in the above-mentioned processing, all the optional devices that can be mounted at the same time in the object apparatus are displayed. However, it is not necessary to choose all the mountable optional devices but may choose some optional devices to be displayed in the appearance image among all the mountable optional devices based on a predetermined rule.

Next, the option information display section 124 acquires the data of the appearance image to be displayed, and the data of the images of the optional devices, which are to be displayed (Step S1).

As for the appearance image, the data of each appearance image according to combination of the present configuration and the non-mounted optional devices to be displayed is preliminarily prepared (stored) in the host computer 1, and the option information display section 124 acquires the data of the appearance image by reading the image data corresponding to combination of the non-mounted optional devices to be displayed and the present configuration.

For example, supposing that the optional devices expressed as the appearance image are only the single-stage paper cassette tray (l) and the double-stage paper cassette tray (m) in the example shown in FIG. 4, the data corresponding to five (5) kinds of appearance images are stored, in which the five kinds includes a first type appearance image which is not equipped with those both sides and does not contain no non-mounted optional devices, a second type appearance image which is not equipped with those both sides, but contains the double-stage paper cassette tray (m) as the non-mounted optional device, a third type appearance image which is not equipped with those both sides, but contains the single-stage paper cassette tray (l) as the non-mounted optional device, a fourth type appearance image which is equipped with the single-stage paper cassette tray (l) and a fifth type appearance image which is equipped with the double-stage paper cassette tray (m). The data corresponding to one type of appearance images among the five kinds of appearance images is acquired.

Moreover, the image which displays each optional device is an icon of each optional device to be displayed near the appearance image, and the data of the icons is preliminarily stored in the host computer 1. As for the icon of each optional device, there are basically four kinds of icons including a first type icon which expresses that the same kind of the optional device has been mounted already and any additional mounting of such kind of the optional device is impossible, a second type icon which expresses that the same kind of the optional device has been mounted already but additional mounting of such kind of the optional device is possible, a third type icon which expresses that the same kind of the optional device is not mounted and also additional mounting of such kind of the optional device is impossible, and a fourth type icon which expresses that the same kind of the optional device is not mounted but additional mounting of such kind of the optional devices is possible. The data corresponding to each type icon for every optional device that can be mounted in the printer 2 is stored in the host computer 1 in a manner such that the data can be read out. However, there are also optional devices which should hold two kinds of data or three kinds of data for each optional device according to the conditions of the exclusive information. As for such optional devices, two or three kinds of data may be stored for each optional device.

The option information display section 124 grasps the status of each optional device, such as mounted, non-mounted, additionally mountable, and additionally non-mountable, by the determination (S5, S8) of the non-mounted optional devices and the determination (S9) whether optional devices are additionally mountable by the option information acquisition section 125. The option information display section 124 selects and acquires the data of the icon expressing the present status of each optional device.

The display data relating to the option information to be displayed in the basic setting window is prepared by this data acquisition (S11), and also the display data of other information to be displayed in the basic setting window is prepared from the status information which is received and the information preliminarily set in the host computer 1. After completion of the preparation of the display of the basic setting window, a user interface section 121 displays the basic setting window on the display device 14 on the basis of the prepared data (Step S12). Further, according to the data acquired by the option information display section 124, the appearance image and the images (icons) of the optional devices are displayed in the basic setting window.

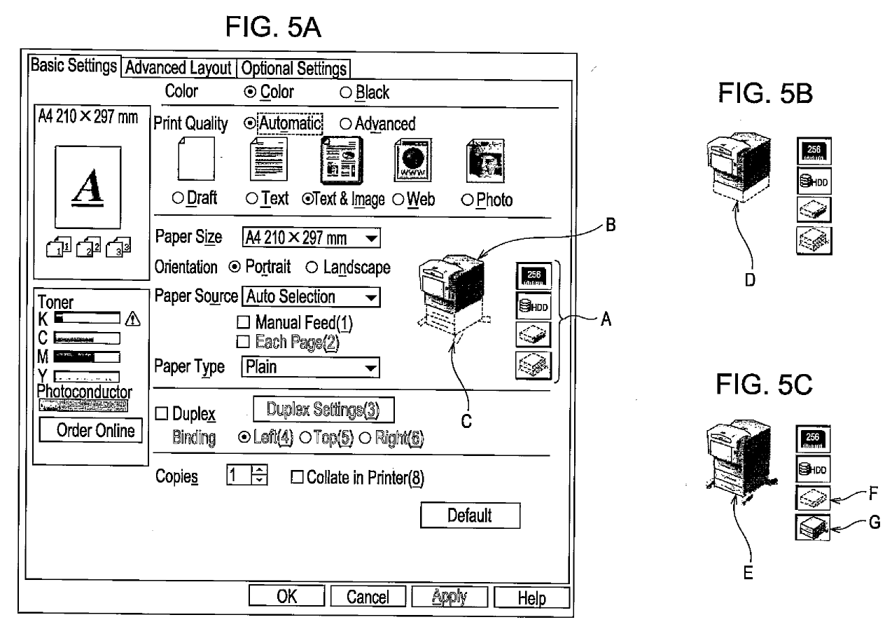

FIGS. 5A to 5C show an example of the basic setting window. FIG. 5A shows the basic setting window to be displayed in the example of FIG. 4. In addition, in this example, the option devices, which can be mounted in the printer 2, include only a memory 256 MB, an HDD unit, a single-stage paper cassette tray, and a double-stage paper cassette tray.

The image shown by B in FIG. SA is an appearance image of the printer 2 at the time of equipping with the non-mounted optional. The upper part of the image shows the present configuration, and the lower part (portion of a dotted line) indicated by C shows the state in which the non-mounted optional devices are mounted in the printer 2. Here, the case in which the double-stage paper cassette tray (m) is chosen as the optional device is shown, and the present configuration and the non-mounted optional devices are displayed so that they are clearly discriminated.

Moreover, the portion shown by A in FIG. 5A is icons of the optional devices. Here, the icons of 256 ME of memory, the HDD unit, the single-stage paper cassette tray, and the double-stage paper cassette tray are displayed in order from the top. The displayed icons are based on the acquired data. The icons of the mounted optional devices are shown by dark color while the icons of the non-mounted optional devices are shown by light color. Moreover, the additionally mountable optional devices are shown by protruding icons (convex-like icons), but the additionally non-mountable optional devices are shown by the depressed icons (concave-like icons). As shown in FIG. 4, since the memory 256 MB and the HDD unit have been mounted already and thus they are not additionally mountable, the icons thereof are in the depressed form and in dark color. On the other hand, as for the single-stage paper cassette tray and the double-stage paper cassette tray, since they have not been mounted yet and thus they are additionally mountable, the icons thereof are light color and protruding. Thus, as described above, all the optional devices that can be mountable in the printer 2 is displayed as the images in the basic setting window in a manner such that the statuses including mounted, non-mounted, additionally mountable, and additionally non-mountable can be discriminated from each other.

In addition, the images of the optional devices expressed as icons may be prepared so that a user can easily identify the optional devices. That is, the images can be pictorial diagram which are abstracted from the view of the optional device, a minute illustration, an on-the-spot photographed picture, a name consisting of character strings, or combination thereof. Further, the discrimination between the mounted and the non-mounted are expressed by shading of color, and the discrimination between the additionally mountable and the additionally non-mountable is expressed by unevenness However, such discrimination is not limited thereto, but may be color, form, or such combination.

The display of the appearance image and the icons of optional devices is performed on the basis of the data of each image which the option information display section 124 acquired.

FIG. 5B is an example of FIG. 4, and shows the basic setting window containing the appearance image and the icons when the single-stage paper cassette tray (l) is selected as the non-mounted optional device. Here, the dotted line part shown by D shows the state at the time when the single-stage paper cassette tray (l) is mounted, and the part D in FIG. 5B is different from FIG. 5A.

FIG. 5C is an example of FIG. 4, and shows the basic setting window containing the appearance image and the icons of the optional devices when the double-stage paper cassette tray (m) is mounted. In such a case, although the single-stage paper cassette tray (l) is not mounted, since the double-stage paper cassette tray (m) is mounted, the single-stage paper cassette tray (l) cannot be additionally mounted. Accordingly, the mounting status of the single-stage paper cassette tray (l) is not displayed in the appearance image, and thus, as for the sheet feeding device, only the present configuration shown by E will be displayed. As for the icons of the optional devices, since both the single-stage paper cassette tray (l) and the double-stage paper cassette tray (m) cannot be additionally mounted, both the single-stage paper cassette tray (l) and the double-stage paper cassette tray (m) are expressed by depressed icons (concave-like icons) shown by F and G.

In such a way, display processing of the basic setting window in this host computer 1 is performed.

In addition, although only the optional devices which are shown from the appearance of the printer 2 are expressed in the example shown in FIGS. 5A, 5B, and 5C, images of the optional devices which are mounted inside the printer 2 and thus are not shown from the appearance of the printer 2, such as memory and HDD unit may be included in the appearance image. For example, imaging the optional devices such as a memory and an HDD unit mounted inside the printer 2 may be to place symbols of such optional devices at predetermined positions in the appearance image. Even in this case, it is preferable that the symbols are displayed so that the presently mounted optional devices and the presently non-mounted optional devices are showing in a distinguishable manner.

Moreover, it is possible for a user to determine whether to display the non-mounted optional devices on the appearance image. In such a case, such determination operation may be performed using the details setting window. Furthermore, it is also possible to allow a user to set up the method of the determination of the optional devices displayed on the appearance image.

Moreover, according to user's directions, that is, when a user clicks one of the icons of the optional devices, the non-mounted optional device displayed on the appearance image can be switched. For example, among icons (A) as shown in FIG. 5A, if the icon of the double-stage paper cassette tray (m), which is the lowermost icon, is clicked, the view indicated by reference symbol C will be shown (see FIG. 5A). However, if the icon of the single-stage paper cassette tray (l) which is the second lowermost icon is clicked, the view indicated by reference symbol D will be shown (see FIG. 5B).

Although the icons of all the optional devices are displayed near the appearance image in the above-mentioned embodiment, only the icons of non-mounted optional devices may be displayed near the appearance image or no icon may be displayed.

Moreover, although the appearance image of the printer 2 is displayed on the basic setting window in the above-mentioned embodiment, it may not be matter that the appearance image is displayed on the details setting window, or both the basic setting window and the details setting window.

Moreover, in the above-mentioned embodiment, although the display of the basic setting window is performed by the host computer 1 but may be alternatively performed by the printer 2. In such a case, the controller of the printer 2 performs the same processing as the printer driver unit 120, and displays the same basic setting window on the display of the operation panel 30 of the printer 2 on it. In addition, it is preferable that the icons of optional devices and the data of the appearance image are stored in the printer 2.

Moreover, in the above-mentioned embodiment, although the printer 2 is a laser beam printer, but may be alternatively a printer using other printing methods.

As explained above, in the information service apparatus according to this embodiment, the appearance image of the object apparatus when the non optional devices, which are not mounted at the time but are mountable, are mounted in the object apparatus is displayed in the user interface window in a manner such that the present configuration of the object apparatus including the optional devices which are mounted at the time, and the present non-mounted optional devices can be discriminated. Accordingly, a user can easily grasp information about the non-mounted optional devices, the information including how the object apparatus changes when the non-mounted optional devices are mounted, by the appearance image, and thus it becomes easy for a user to pursue the effective and efficient usage of the object device using the optional devices. As a result, it is possible to stimulate the increase in the purchase opportunity of the optional devices. Furthermore, it is effective in arrangement examination of the object apparatus because all the optional devices that can be added to the present configuration of the object apparatus are displayed on the appearance image.

Moreover, since images of the optional devices mounted inside the apparatus are also displayed with the appearance image, it is possible to perform information service more intelligibly about the optional devices.

Moreover, since the icon of each of the optional devices is displayed near the appearance image in a manner such that the mounting status (mounted/non-mounted) and the possibility of additional mounting (possible/impossible) can be easily discriminated, it is possible to perform more kindly the information service about the optional devices.

Furthermore, since the optional devices are displayed as images, it is easy to understand to anyone regardless of the language used, and it is not necessary to change an interface relating to the concerned processing for each use country.

Moreover, since the appearance image containing the non-mounted optional devices is displayed on the basic setting window, the details setting window, or both of them, it is possible to provide a user with information about the non-optional devices in a manner such that the user can easily understand the non-mounted optional devices.

Although the object apparatus in which the optional devices are mounted is the printer in the embodiments and the printer is suitable for a subject of the invention since various kinds of optional devices can be mounted thereto, but the object apparatus is not limited to the printer, but may be other apparatuses, such as a copying machine, as long as it is possible to add optional devices to the apparatuses.

The scope of protection of the invention is not limited to the above-mentioned embodiments but covers the invention described in the claim, and its equivalent.

What is claimed is:

1. An information service program which causes an information service apparatus performs processing of information service about optional devices, which are mountable in an object apparatus, the processing comprising:
determining present configuration of the object apparatus including mounted optional devices which are mounted in the object apparatus, and non-mounted optional devices which are optional devices which are not mounted but are mountable in the object apparatus, by acquiring information about mounting status of the optional devices in the object apparatus; and
displaying an appearance image of the object apparatus, which is to be configured when the non-mounted object devices are further additionally mounted in the object apparatus, to a user so that the user can discriminate between the present configuration of the object apparatus and the non-mounted optional devices.

2. The information service program according to claim 1, wherein images showing the optional devices mounted inside the object apparatus are displayed altogether with the appearance image which is displayed.

3. The information service program according to claim 1, wherein images showing the non-mounted optional devices are displayed near the appearance image which is displayed.

4. The information service program according to claim 3, wherein the images showing the mounted optional devices are displayed near the appearance image in a manner such that they can be distinguished from the images showing the non-mounted devices.

5. The information service program according to claim 3, wherein the images showing the non-mounted optional devices are displayed in a manner such that whether the non-mounted devices can be added to the present configuration.

6. The information service program according to claim 1, wherein a window which is an interface window for allowing a user to perform setting operation with respect to the object apparatus, and which consists of a basic setting window and a details setting window, and wherein the basic setting window displays the appearance image thereon.

7. The information service program according to claim 1, wherein the object apparatus is a printer, the information service apparatus is the printer or a host device of the printer.

8. An information service apparatus which performs information service about optional devices which can be mounted in an object apparatus, comprising:
an information acquisition unit which determines present configuration of the object apparatus including mounted optional devices which are mounted in the object apparatus, and non-mounted optional devices which are optional devices which are not mounted but are mountable in the object apparatus, by acquiring information about mounting status of the optional devices in the object apparatus; and
an information display unit which displays an appearance image of the object apparatus at the time of being equipped with the non-mounted optional devices to a user so that the user can discriminate between the present configuration of the object apparatus and the non-mounted optional devices.

9. An information service method in an information service apparatus which performs information service about optional devices that can be mounted in an object apparatus, the method comprising:
allowing the information service apparatus to determine present configuration of the object apparatus including mounted optional devices which are mounted in the object apparatus, and non-mounted optional devices which are optional devices which are not mounted but mountable in the object apparatus, by acquiring information about mounting status of the optional devices in the object apparatus; and
allowing the information service apparatus to display an appearance image of the object apparatus at the time of being equipped with the non-mounted optional devices to a user so that the user can discriminate between the present configuration of the object apparatus and the non-mounted optional devices.
